(19) United States
(12) Patent Application Publication
(10) Pub. No.: US 2024/0350839 A1
(43) Pub. Date: Oct. 24, 2024

(54) ADJUSTABLE MASK AND HOOD SYSTEM

(71) Applicant: AIRBOSS DEFENSE GROUP, INC., Jessup, MD (US)

(72) Inventors: Mario Champigny, Quebec (CA); Jandro Latendresse, Quebec (CA); Celine Michaud, Quebec (CA); Maude Tremblay, Quebec (CA); Ian Roy, Jessup, MD (US)

(21) Appl. No.: 18/622,802

(22) Filed: Mar. 29, 2024

Related U.S. Application Data
(60) Provisional application No. 63/455,411, filed on Mar. 29, 2023.

(51) Int. Cl. A62B 18/02; A62B 18/08

(52) U.S. Cl. CPC A62B 18/02; A62B 18/084

(57) ABSTRACT

Adjustable CBRN mask systems are disclosed including a face mask with a face cover, a lens disposed in and surrounded by the face cover, and a gas interface disposed in and surrounded by the face cover. A hood surrounds, and is removably attached to, the face mask, and includes a hood adjustment mechanism with a draw string to tighten the hood at the crown of the wearer's head and around and/or below the wearer's chin. The hood adjustment mechanism may be tightened by pulling an adjustment handle forward from below the wearer's chin, and loosened by pulling a separate release handle rearward from behind the wearer's head.

### BACKGROUND

The disclosure relates generally to respirator masks for chemical, biological, radiological and nuclear (CBRN) protection and other applications.

Respirator masks, sometimes referred to as “gas masks”, are used extensively in chemical, biological, radiological and nuclear (CBRN) defense and other applications (e.g., other military, industrial or police applications) to protect a wearer against inhalation of noxious agents (e.g., chemical agents, biological agents, radiological agents, and/or other poisonous or otherwise harmful agents that can cause disease, injury or death). These masks may also provide protection for the wearer's eyes and/or skin.

It is typically desirable to have a respirator mask which, besides protecting its wearer, will minimally affect comfort and/or performance of the wearer. For example, low respiratory resistance is important to avoid making it difficult for the wearer to properly breathe. Thus, proper filtration and low resistance to airflow are normally desirable, although they may often be conflicting requirements.

Known masks suffer from a number of limitations related to, for example, the nature of the threat they are designed to counter, and various user-specific fitting challenges, such as head and/or facial structure, hair, etc. For example, the use of a mask alone may be ineffective against certain threats that can cause harm via any exposed skin. Additionally, achieving a proper seal for protecting the user can be inhibited or interfered with because of a user's head or facial structure, long or bulk hair styles on the user's head, various styles and lengths of facial hair, etc. For example, when a Conventional General Service Respirator (GSR) is used in negative pressure mode with a filter canister it is dependent on the mask to face seal. The user evaluates protection by creating vacuum inside mask (inhaling while blocking canister inlet), and confirming vacuum is maintained for 5 seconds. However, this approach may be unworkable for users with, for example, a beard, small face, or forward hair line that may disrupt the mask seal.

### SUMMARY

According to various aspects of the disclosure, there is provided an adjustable CBRN mask system including one or more of a face mask including a face cover, a lens disposed in and surrounded by the face cover, and/or a gas interface disposed in and surrounded by the face cover. The mask system may include a hood that surrounds, and may removably attached to, the face mask, and a hood adjustment mechanism.

In embodiments, the hood may be configured to fully cover a wearer's head, to extend below the wearer's neckline, and/or to drape at least partially on and/or around the wearer's shoulders.

In embodiments, the hood adjustment mechanism may include a draw string configured to tighten the hood at the crown of the wearer's head and around and/or below the wearer's chin.

In embodiments, the hood adjustment mechanism may be configured to be tightened by pulling an adjustment handle forward from below the wearer's chin, and loosened by pulling a separate release handle rearward from behind the wearer's head.

In embodiments, the draw string extends along a curve running from the front of the hood below the face mask, to the back of the hood, and up to the top of the hood.

In embodiments, the hood adjustment mechanism may be configured to accommodate parallel parts of the draw string along a pair of expandable channels running from the top of the hood to the back of the hood.

In embodiments, the release handle may be disposed below and between the expandable channels.

In embodiments, the hood may include a stow ring around a bottom of the hood, and at least part of the hood may be configured to stow within the stow ring and to be pulled from the stow ring as the mask system is donned.

In embodiments, the gas interface may be configured to attach to a filter cannister and may include a seal that allows gas to enter the face mask when the filter cannister is attached and prevents gas entering the face mask when the filter cannister is not attached.

In embodiments, the hood may be configured to form a negative pressure seal when draped over a CBRN top worn by the wearer.

In embodiments, the negative pressure seal provides a sufficient seal such that, when the wearer inhales, gas is drawn through a filter attached to the gas interface rather than through the bottom of the hood.

According to further aspects of the disclosure, there is provided a CBRN mask system, including one or more of a face mask including a flexible face covering, a lens disposed in and surrounded by the flexible face covering, and a gas interface disposed in and surrounded by the flexible face covering; a hood that surrounds, and may be removably attached to, the face mask; and/or a hood adjustment mechanism. In embodiments, the hood may be configured to fully cover a wearer's head, to extend below the wearer's neckline, and/or to drape around the wearer's shoulders.

In embodiments, the hood adjustment mechanism may include a draw string that configured to tighten the hood at the crown of the wearer's head and around the wearer's chin.

In embodiments, the hood may be configured to form a negative pressure seal when draped over a CBRN top worn by the wearer.

In embodiments, the negative pressure seal provides a sufficient seal such that, when the wearer inhales, gas is drawn through a filter attached to the gas interface rather than through the bottom of the hood.

In embodiments, the hood adjustment mechanism may be configured to be tightened by pulling an adjustment handle forward from below the wearer's chin, and loosened by pulling a separate release handle rearward from behind the wearer's head.

In embodiments, the hood adjustment mechanism may include a friction lock that is configured to sinch the draw string as the draw string is pulled by the adjustment handle and to release the draw string when the release handle is pulled.

According to another aspect of the disclosure, a mask system may include one or more of a face mask including a face cover, a lens disposed in and surrounded by the face cover, and/or a gas interface disposed in and surrounded by the face cover. Embodiments may include a hood that surrounds, and may be removably attached to, the face mask; and a hood adjustment mechanism.

In embodiments, the hood may be configured to fully cover a wearer's head, to extend below the wearer's neckline, and to drape at least partially on and/or around the wearer's shoulders.

In embodiments, the hood adjustment mechanism may be configured to tighten and/or loosen the hood at the crown of the wearer's head and around and/or below the wearer's chin such that the hood can accommodate bulk hair styles on the wearer's head, and/or a beard on the wearer's chin.

In embodiments, the hood can accommodate bulk hair styles on the wearer's head, and/or a beard on the wearer's chin while maintaining a seal around the bottom of the hood.

In embodiments, the hood may include a stow ring around the bottom of the hood, and at least part of the hood may be configured to stow within the stow ring and to be pulled from the stow ring as the mask system is donned.

In embodiments, the hood adjustment mechanism may include an adjustment handle disposed below the wearer's chin, and an adjustment cord that runs from the adjustment handle toward the back of the hood and up to the crown of the hood.

In embodiments, the adjustment cord runs in two separate strands from the adjustment handle toward the back of the hood and up to the crown of the hood, each of the separate strands weaving through parallel expandable channels of the hood.

According to further aspects of the disclosure, a CBRN mask system may be provided including one or more of a face mask including a face cover, a lens disposed in and surrounded by the face cover, and/or a gas interface disposed in and surrounded by the face cover.

Embodiments may include a hood that surrounds, and may be removably attached to, the face mask; and a hood adjustment mechanism.

In embodiments, the hood may be configured to fully cover a wearer's head, to extend below the wearer's neckline, and to drape at least partially on and/or around the wearer's shoulders.

In embodiments, the hood adjustment mechanism may be configured to tighten and/or loosen the hood at the crown of the wearer's head and around and/or below the wearer's chin such that the hood can accommodate head/facial geometries that do not form an adequate seal with a CBRN mask alone.

In embodiments, the hood can accommodate head/facial geometries that do not form an adequate seal with a CBRN mask alone while maintaining a negative pressure seal around the bottom of the hood.

In embodiments, the hood may include a stow ring around the bottom of the hood, and at least part of the hood may be configured to stow within the stow ring and to be pulled from the stow ring as the mask system is donned.

In embodiments, the hood adjustment mechanism may include an adjustment handle disposed below the wearer's chin, and an adjustment cord that runs from the adjustment handle toward the back of the hood and up to the crown of the hood.

In embodiments, the adjustment cord runs in two separate strands from the adjustment handle toward the back of the hood and up to the crown of the hood, each of the separate strands weaving through parallel expandable channels of the hood.

In embodiments, the mask may be a CBRN mask.

In embodiments, the mask may include an exhaust valve that is configured to allow gas to escape from the inner volume of the mask without passing back through the filter.

These and other aspects of the invention will become apparent to those of ordinary skill in the art upon review of the following description of embodiments in conjunction with the accompanying drawings.

### BRIEF DESCRIPTION OF THE DRAWINGS

A detailed description of embodiments of the invention is provided below, by way of example only, with reference to the accompanying drawings, in which:

FIG. 1 depicts an exemplary CBRN mask being worn by a user, with areas of design and fit concern identified in dashed lines.

FIG. 2A shows a front view of an exemplary mask and hood design including adjustment features;

FIG. 2B shows a side view of an exemplary mask and hood design including adjustment features;

FIG. 2C shows a rear view of an exemplary mask and hood design including adjustment features;

FIG. 3A shows a front view of a hood design for wearing under a CBRN mask;

FIG. 3B shows a side view of a hood design for wearing under a CBRN mask;

FIG. 3C shows a rear view of a hood design for wearing under a CBRN mask;

FIG. 4A shows a front view of the hood design from FIG. 3A, with a CBRN mask donned over the hood;

FIG. 4B shows a side view of the hood design from FIG. 3B, with a CBRN mask donned over the hood;

FIG. 4C shows a rear view of the hood design from FIG. 3C, with a CBRN mask donned over the hood;

FIG. 5A shows a front view of an example of an integrated CBRN mask and hood;

FIG. 5B shows a side view of an example of an integrated CBRN mask and hood;

FIG. 5C shows a rear view of an example of an integrated CBRN mask and hood;

FIG. 6A shows a front view of another example of an integrated CBRN mask and hood prototype;

FIG. 6B shows a side view of another example of an integrated CBRN mask and

hood prototype;

FIG. 6C shows a rear view of another example of an integrated CBRN mask and hood prototype; and

FIGS. 7-10 all depict various aspects of another integrated CBRN mask and hood prototype.

It is to be expressly understood that the description and drawings are only for the purpose of illustrating certain embodiments of the invention and are an aid for understanding. They are not intended to be a definition of the limits of the invention.

### DETAILED DESCRIPTION OF EMBODIMENTS

It is understood that the invention is not limited to the particular methodology, protocols, etc., described herein, as these may vary as the skilled artisan will recognize. It is also to be understood that the terminology used herein is used for the purpose of describing particular embodiments only, and is not intended to limit the scope of the invention. It also is to be noted that as used herein and in the appended claims, the singular forms “a,” “an,” and “the” include the plural reference unless the context clearly dictates otherwise. Thus, for example, a reference to “a lens” is a reference to one or more lenses and equivalents thereof known to those skilled in the art.

Unless defined otherwise, all technical terms used herein have the same meanings as commonly understood by one of ordinary skill in the art to which the invention pertains. The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law.

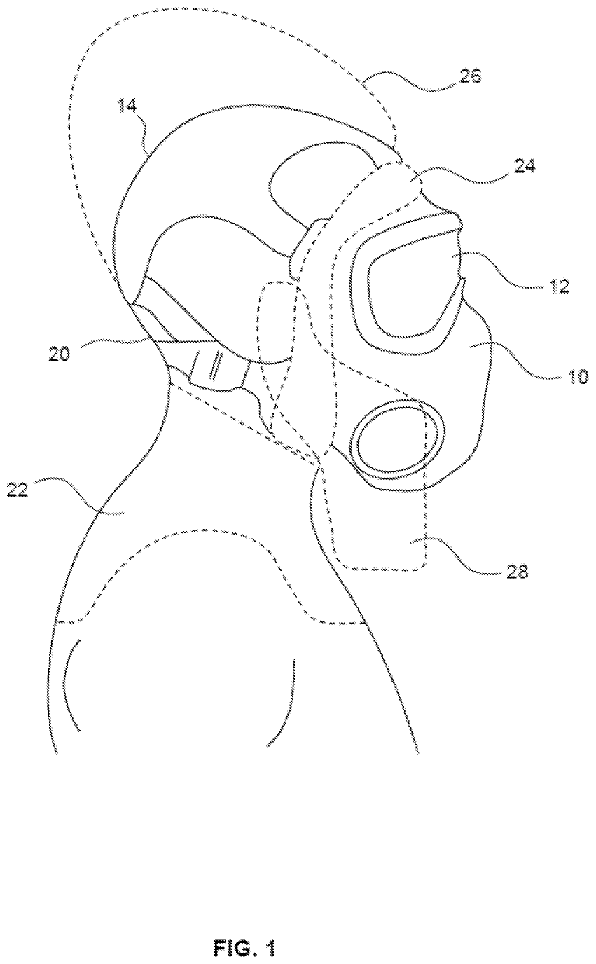

FIG. 1 shows an exemplary CBRN mask being worn by a user, with areas of design and fit concern identified in dashed lines. As shown in FIG. 1, the mask 10 includes a lens 12, and a head harness 14. The mask 10 may be donned by expanding adjustments in the rear, neck area 20. Depending on aspects of the user's head shape, neck size, hair style/bulk, etc., this can present design challenge in ensuring that the mask 10 is easily donned and doffed, while maintaining sufficient retention to seal the mask 10 to the user's face. Likewise, around the facial seal area 24, the user's facial shape and size, beard style/bulk, etc., can also present design challenge in ensuring that the mask 10 is easily donned and doffed, while maintaining sufficient retention to seal the mask 10 to the user's face. Different hair bulk/styles as well as beard bulk/styles are becoming more diverse as, for example, units that require CBRN protection become more integrated along the lines of gender, religion, and ethnicity, all of which can present unique challenges that conventional CBRN masks fail to accommodate.

The protection approach discussed herein is based on five main work zones; the hair area 26, where various hair bulk/styles may be encountered, as well as turbans, patkas, hijabs, etc.; the face area, where beard facial hair, hijabs, low frontal and temporal hair lines, turbans, patkas, hijab fabric interferences, etc. may be encountered; the beard area 28; the back of the head; and the neck area. Also, in some instances it may be necessary to stabilize a hood on the shoulders 22 after a CBRN top or suit is donned.

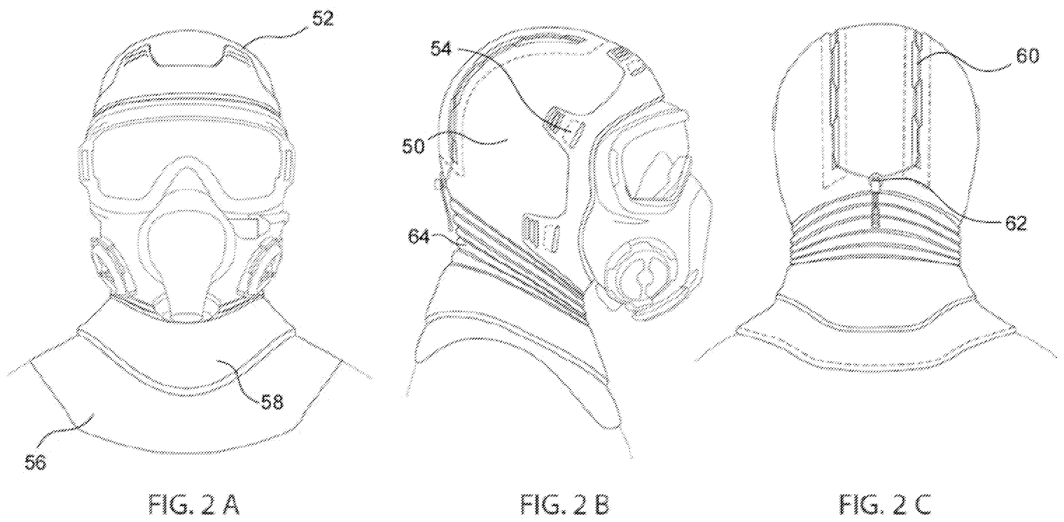

FIGS. 2A-2C show an exemplary mask and hood design including adjustment features that address one or more of the identified work zones. The hood system shown in FIGS. 2A-2C is worn over the CBRN mask and includes a base layer 50 and an embossed ridge 52 around the mask interface, which may provide added grip around the mask. The ridge 52 may include one or more integrated hooks 54 or other attachment mechanisms for securing the hood to the mask and/or inhibiting the hood from pulling away from the mask. The front collar 56 of the hood drapes over or under a CBRN garment and may include raised, recessed and/or deformable geometry patterning 58, e.g. using memory foam, etc. The volume and/or shape of the base layer may be adjusted via one or more cable gussets 60 running fore and aft on the hood. The cables may be joined at a back of the hood, where they can be pulled by the user, and may include a releasable locking mechanism 62 to secure the cable(s) at a desired fit length. The hood system may also include a gathering area 64 around the back of the head, neck and/or chin area that allows automatic or manual adjustment of the volume and/or shape of the hood in these areas.

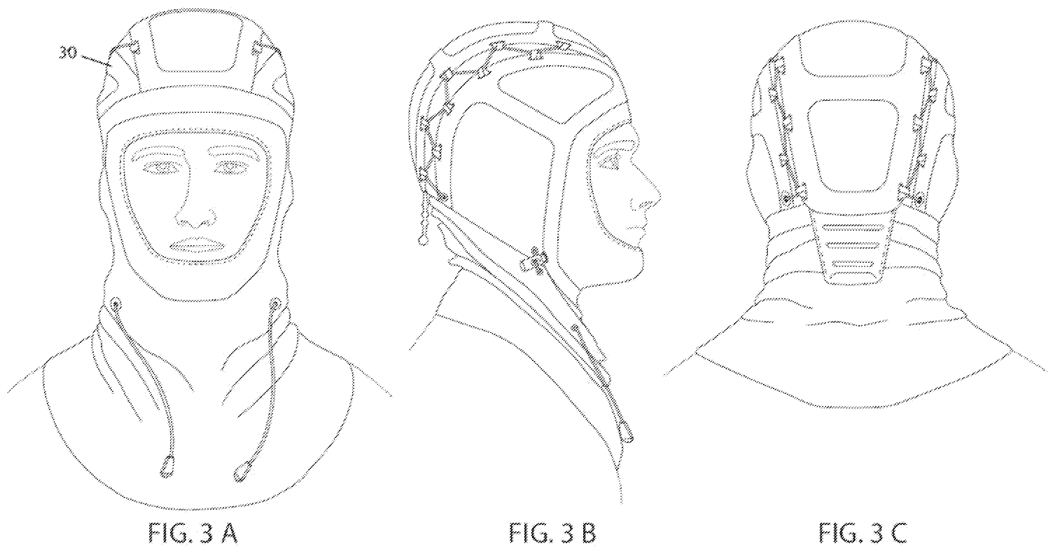

FIGS. 3A-3C show an exemplary hood design including adjustment features that address one or more of the identified work zones. The hood 30 shown in FIG. 3 is worn under the CBRN mask and includes a base layer and seal area around the user's face. The front collar of the hood drapes over a CBRN garment. The volume and/or shape of the base layer may be adjusted via one or more cable gussets running fore and aft on the hood. The cables extend from area under the user's chin, where they can be pulled to adjust the fit of the hood. Another adjustment, or release, tab may be included at the rear of the hood to provide additional adjustability and/or to allow the cable(s) to be easily slacked. The hood 30 may include a surplus of material around the back of the head, neck and/or chin area that allows adjustment of the volume and/or shape of the hood in these areas, e.g. to allow for various hair and/or beard bulk/styles.

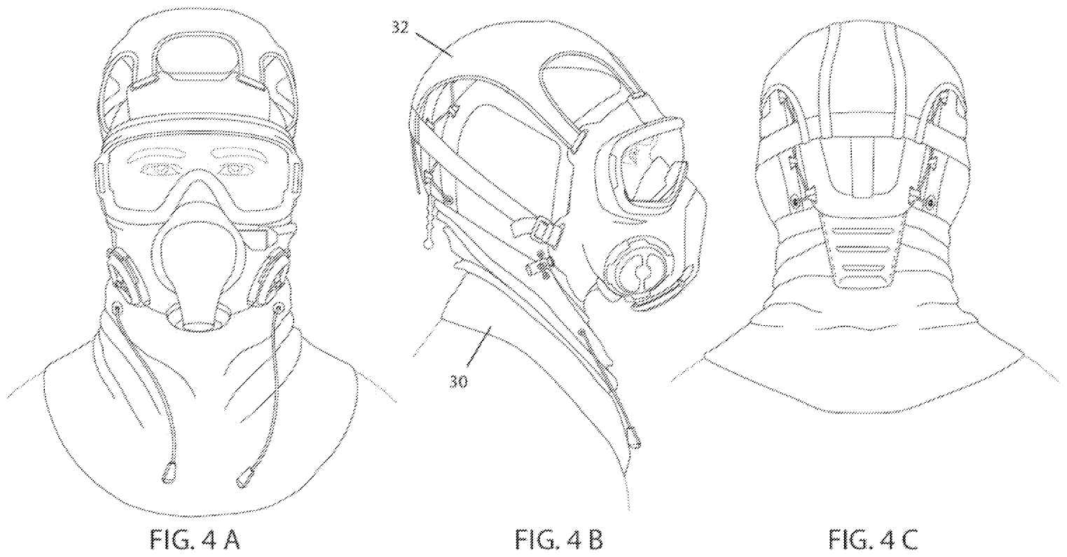

FIGS. 4A-4C show the hood 30 from FIGS. 3A-3C worn under the CBRN mask 32. The mask 32 is joined to sealed around the base layer of the hood 30 via a corresponding seal area around the user's face, and held in place via a head harness over the top of the hood.

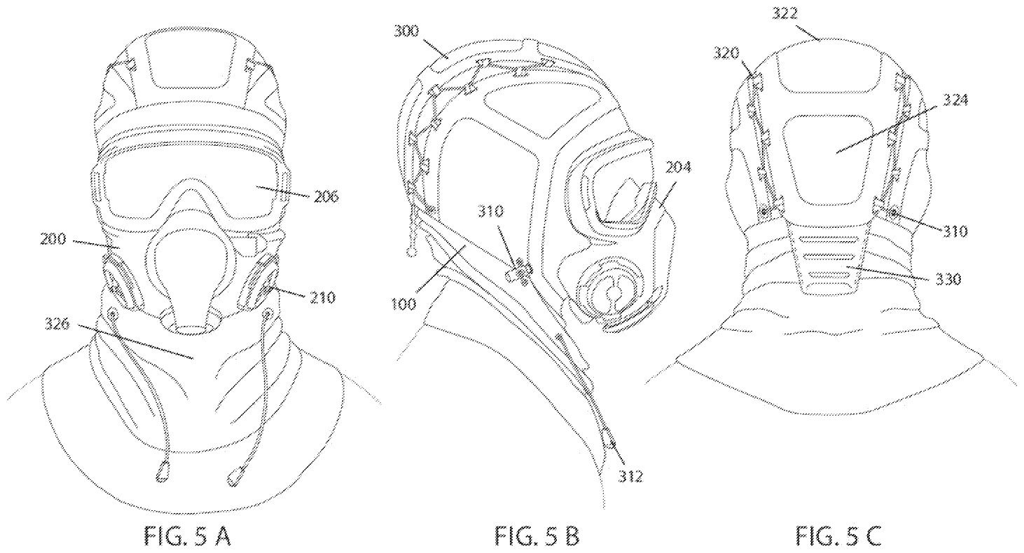

FIGS. 5A-5C show an exemplary integrated mask and hood design including adjustment features that address one or more of the identified work zones. The mask system 100 shown in FIG. 5 integrates the CBRN mask 200 with the hood 300. The hood 300 may preferably be sealed to exterior of the mask 200, e.g. via double sided sealing tape, or other means known in the art.

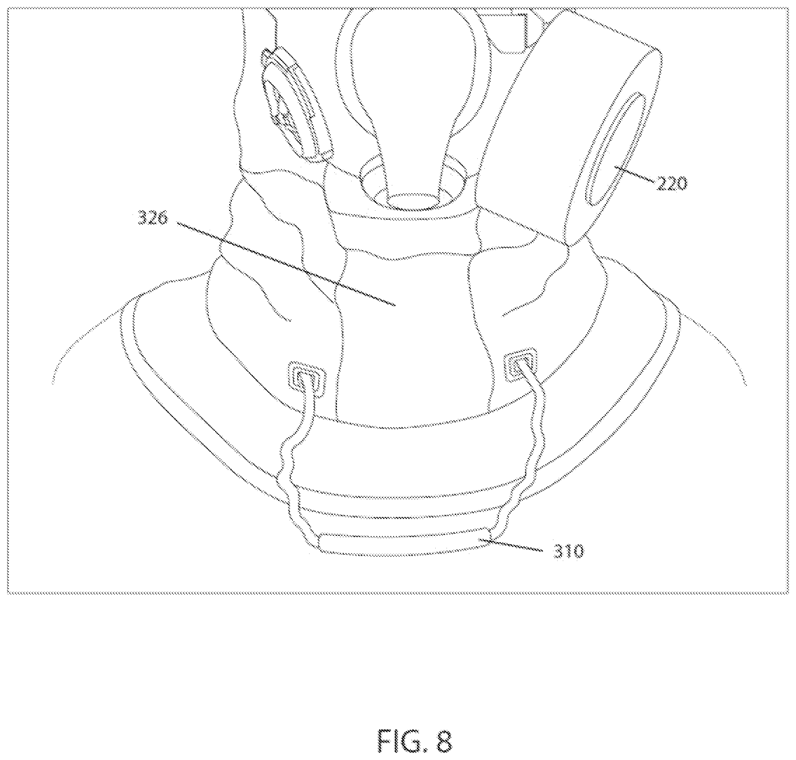

The mask 200 includes a flexible face cover 204 and a lens 206 that is surrounded by the face cover 204. Embedded in the face cover is a gas interface 210. The gas interface 210 may be configured to a receive a filter cannister (such as filter canister 220 shown in FIG. 8). The gas interface 210 may include a seal that prevents air or other gasses from entering the mask unless the filter canister is attached to the gas interface.

The hood 300 includes a base layer of protective fabric that forms the majority, or all, of the outer surface of the hood. The hood may include another material that is attached to the base layer and that is relatively more rigid than the base layer. This other material (e.g. foam, composite, plastic, extra and/or reinforced layer(s) of the base material, etc.) may be used to form a more consistent shape on part(s) of the hood, around which excesses of the base layer material can be drawn to or away from. For example, a relatively rigid material frame may run along each side of the gussets 320 and, when the adjustment draw string 312 is pulled, the sides of the gusset may be drawn towards each other in a relatively controlled manner compared to pulling only on the base layer.

The hood 300 may include an adjustment mechanism with one or more draw strings 312 that allow retraction and/or expansion of the volume or shape of particular parts of the hood. This can be accomplished, for example, by running the draw strings 312 through opposite sides of channels 320 from below the chin area 326, up and around the hood back 324, over the hood crown 322, toward the brow. An adjustment/release tab 330 is included at the rear of the hood, which is configured to loosen and/or withdraw from the cinching tabs that hold the draw string 312 after they are pulled from under the chin. The adjustment/release tab 330 can be used to more or less fully release the tension on the draw strings 312 and/or adjustment mechanism more broadly as might be required for doffing the mask system 100.

The collar of the mask system 100 drapes over a CBRN garment and provides a negative-pressure seal sufficient to bias inhaled air through the filter cannister rather than up through the neck of the hood. That is, although not necessarily an air-tight seal, the seal formed by weighting, draping, contacting, channeling, etc. around the neck and shoulder area of the hood is greater than the negative pressure provided by the filter cannister. So, when the user inhales, air is drawn through the filter canister, rather than up through the neck of the hood.

Excess material may be included, for example, between the sides of each channel 320, at the back of the hood 324, around the neck of the hood, all of which may be cinched or released to better accommodate variations in hair and/or beard bulk/styling, head and/or facial feature size/shape, neck size, headdress and other user variations inside the hood.

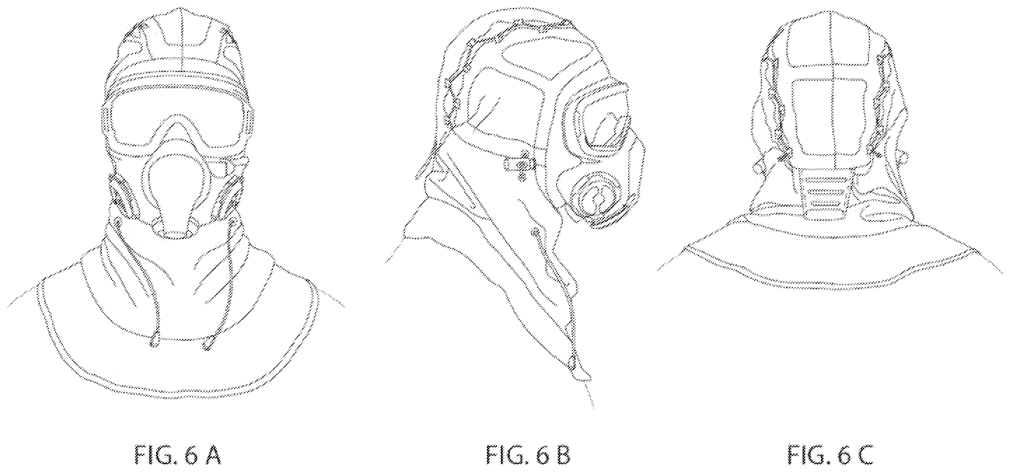

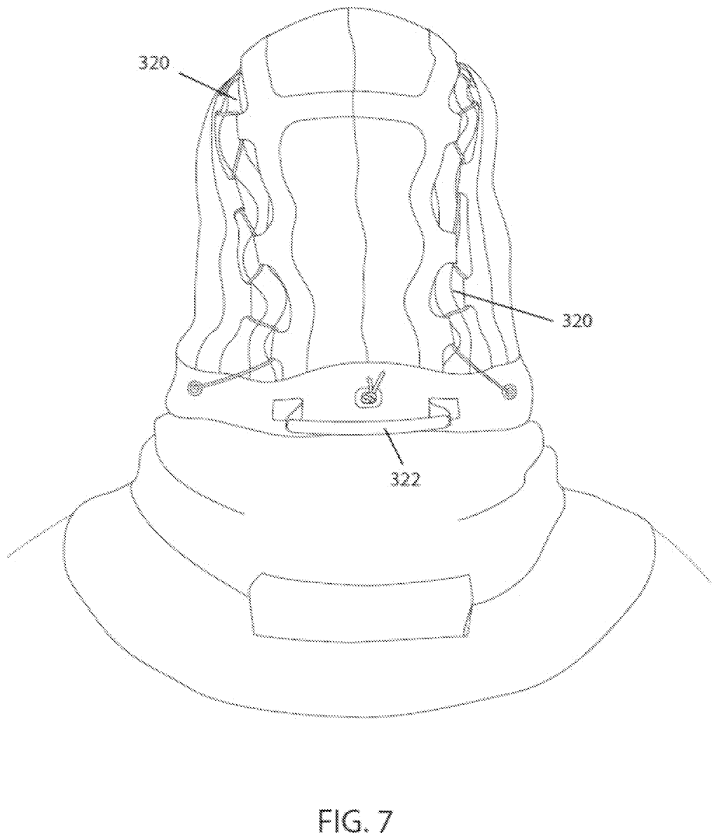

Additional features of a similar mask system are shown in FIGS. 6A-6C, which depicts a manufactured prototype. This prototype shares many of the features from the example shown in FIG. 7. In this example, the second material includes one or more reinforced layers of the base layer material.

Another exemplary embodiment is shown in FIGS. 7-10, which depict another manufactured prototype. This prototype shares many of the features from the examples shown in FIGS. 7 and 8. However, in this example, the hood includes a release handle 332, shown in FIG. 7, which is positioned at the back of the hood (e.g. between and/or below the channels 320, and/or below the base of the wearer's skull), and an adjustment handle 310, shown in FIG. 8, which is positioned at the front of the hood under the chin area.

The draw string(s) runs from the ends of adjustment handle 310, in to the hood, where the draw string(s) run through cinching tabs (or other friction lock) that hold the draw string(s) as it is pulled by the adjustment handle 310. The draw string(s) run around the neck, up the back of the hood, up to the crown, and toward the brow. More specifically, the draw string(s) extend along a curve running from the front of the hood below the face mask, to the back of the hood, and up to the top of the hood. When the user pulls the adjustment handle 310 the effective length of the draw string(s) are shortened, thereby gathering excess material together, e.g. around the chin area as shown in FIG. 8, along the channels running up the back and toward the front of the skull as shown in FIG. 7 and/or around the neck area.

The cinching tabs are disposed at a position between the adjustment handle 310 and the release handle 332, so that when the user pulls back on the release handle 332, the draw string(s) are pulled back through the cinching tabs, increasing the effective length of the draw string(s), thereby billowing excess material, e.g. along the channels and/or around the neck area. In this example, the release handle 332 is configured to release the draw string(s) from retention by pulling the handle in a direction (e.g. back and up) that is more or less opposite to the adjustment handle's direction of pull (e.g. forward and down).

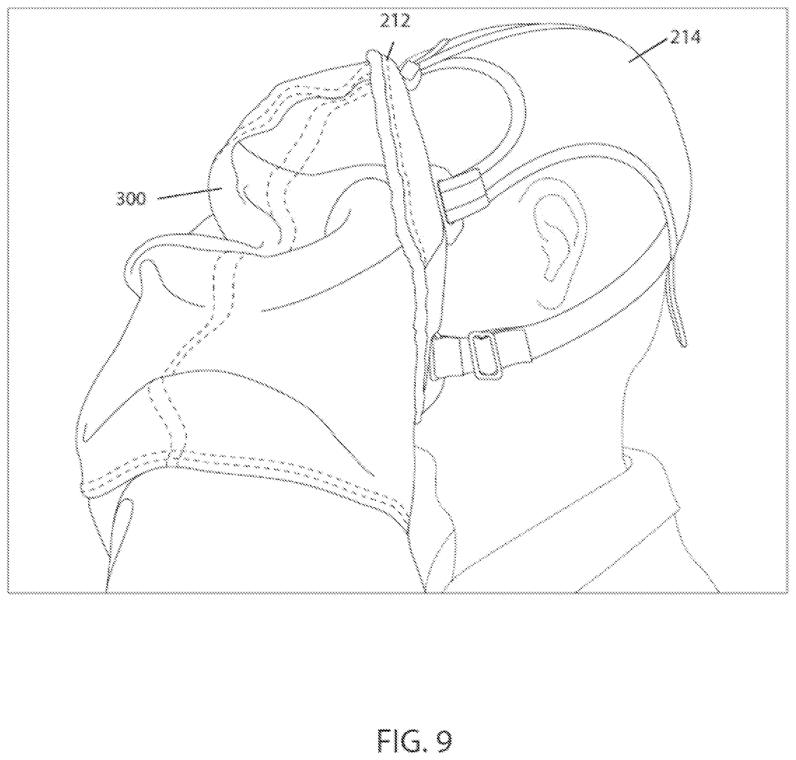

FIG. 9 also shows details of how the hood 300 is joined to the mask at the seal 212. The seal 212 may be formed as a permanent seal, e.g. using molding, chemical, and/or heat treatment, or may be a removable seal, allowing the mask or hood to be replaced as needed. For donning the mask system, the wearer will typically place the mask 200 around the face, pull the head harness 214 over the crown of the head, and then pull the hood 300 over the head. After that, the wearer can ensure that adequate space in the hood is allowed for bulk hair and/or beard, headdress, etc., and the hood can be adjusted/cinched by pulling the adjustment handle 310. To doff the mask system, the wearer can release the adjustment mechanism by pulling back on the release handle, pull the back of the hood up and over the head, and then remove the mask by releasing the head harness.

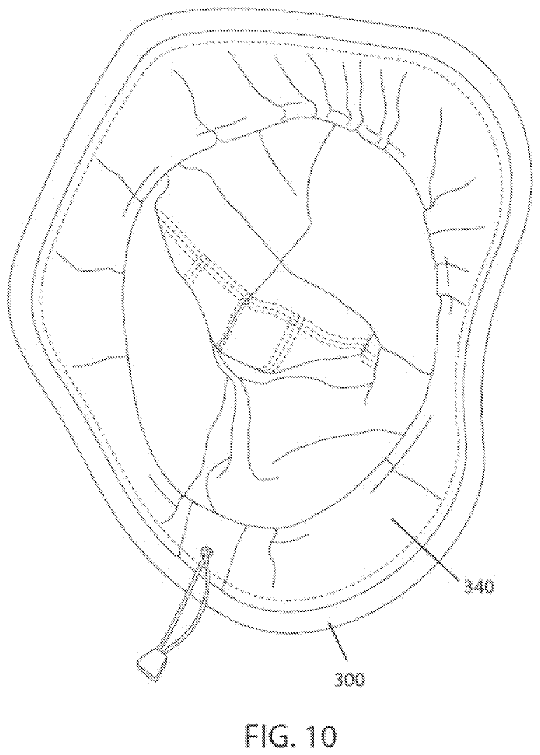

As shown in FIG. 10, the shoulder area of the hood may also include an area to stow the majority of the hood. In this case, an annular stow ring 340 is included inside the perimeter of the hood's opening (i.e. around the area that drapes the wearer's shoulders. The base layer material can be rolled, folded, or stuffed into the stow ring between the outer base layer and an annular pocket made of an elastic or other material. When the wearer dons the mask system, the part of the hood that is stowed in the pocket is pulled out as the hood is drawn over the head and around the shoulders.

In the example shown, for example, in FIGS. 7-10, the hood adjustment mechanism is configured to tighten and loosen the hood at the crown of the wearer's head and around and below the wearer's chin such that the hood can accommodate head/facial geometries that do not form an adequate seal with a CBRN mask alone. This system can also accommodate head/facial geometries that do not form an adequate seal with a CBRN mask alone while maintaining a negative pressure seal around the bottom of the hood.

The system shown, for example, in FIGS. 7-10, can also include an exhaust valve on the opposite cheek of the filter cannister 220, that is configured to allow gas to escape from the inner volume of the mask without passing back through the filter.

The foregoing configuration has been found to, for example, create sufficient space to accommodate the extra volume generated by the various head dresses, accommodate beard facial hair, hijab, low frontal and temporal hair line, turban, patka, hijab fabric interferences, provide smooth movement and snug fit along the back of the head, and provide stability for the hood, particularly when donning the system, all while maintaining protection and user comfort.

Any feature of any embodiment discussed herein may be combined with any feature of any other embodiment discussed herein in some examples of implementation.

Certain additional elements that may be needed for operation of certain embodiments have not been described or illustrated as they are assumed to be within the purview of those of ordinary skill in the art. Moreover, certain embodiments may be free of, may lack and/or may function without any element that is not specifically disclosed herein.

Although various embodiments and examples have been presented, this was for the purpose of describing, but not limiting, the invention. Various modifications and enhancements will become apparent to those of ordinary skill in the art and are within the scope of the invention, which is defined by the appended claims,

What is claimed:

1. An adjustable CBRN mask system, comprising:
a face mask including a face cover, a lens disposed in and surrounded by the face cover, and a gas interface disposed in and surrounded by the face cover;
a hood that surrounds, and is removably attached to, the face mask; and
a hood adjustment mechanism,
wherein, the hood is configured to fully cover a wearer's head, to extend below the wearer's neckline, and to drape at least partially on or around the wearer's shoulders,
the hood adjustment mechanism includes a draw string configured to tighten the hood at the crown of the wearer's head and around or below the wearer's chin; and
the hood adjustment mechanism is configured to be tightened by pulling an adjustment handle forward from below the wearer's chin, and loosened by pulling a separate release handle rearward from behind the wearer's head.

2. The CBRN mask system of claim 1, wherein the draw string extends along a curve running from the front of the hood below the face mask, to the back of the hood, and up to the top of the hood.

3. The CBRN mask system of claim 1, wherein the hood adjustment mechanism is configured to accommodate parallel parts of the draw string along a pair of expandable channels running from the top of the hood to the back of the hood.

4. The CBRN mask system of claim 3, wherein the release handle is disposed below and between the expandable channels.

5. The CBRN mask system of claim 1, wherein the hood includes a stow ring around a bottom of the hood, and at least part of the hood is configured to stow within the stow ring and to be pulled from the stow ring as the mask system is donned.

6. The CBRN mask system of claim 1, wherein the gas interface is configured to attach to a filter cannister and includes a seal that allows gas to enter the face mask when the filter cannister is attached and prevents gas entering the face mask when the filter cannister is not attached.

7. The CBRN mask system of claim 1, wherein the hood is configured to form a negative pressure seal when draped over a CBRN top worn by the wearer.

8. The CBRN mask system of claim 7, wherein the negative pressure seal provides a sufficient seal such that, when the wearer inhales, gas is drawn through a filter attached to the gas interface rather than through the bottom of the hood.

9. An adjustable CBRN mask system, comprising:
a face mask including a flexible face covering, a lens disposed in and surrounded by the flexible face covering, and a gas interface disposed in and surrounded by the flexible face covering;
a hood that surrounds, and is removably attached to, the face mask; and
a hood adjustment mechanism,
wherein, the hood is configured to fully cover a wearer's head, to extend below the wearer's neckline, and to drape around the wearer's shoulders,
the hood adjustment mechanism includes a draw string that configured to tighten the hood at the crown of the wearer's head and around the wearer's chin; and
the hood is configured to form a negative pressure seal when draped over a CBRN top worn by the wearer.

10. The CBRN mask system of claim 9, wherein the negative pressure seal provides a sufficient seal such that, when the wearer inhales, gas is drawn through a filter attached to the gas interface rather than through the bottom of the hood.

11. The CBRN mask system of claim 9, wherein the hood adjustment mechanism is configured to be tightened by pulling an adjustment handle forward from below the wearer's chin, and loosened by pulling a separate release handle rearward from behind the wearer's head.

12. The CBRN mask system of claim 11, wherein the hood adjustment mechanism includes a friction lock that is configured to sinch the draw string as the draw string is pulled by the adjustment handle and to release the draw string when the release handle is pulled.

13. A CBRN mask system, comprising:
a face mask including a face cover, a lens disposed in and surrounded by the face cover, and a gas interface disposed in and surrounded by the face cover;
a hood that surrounds, and is removably attached to, the face mask; and
a hood adjustment mechanism,
wherein, the hood is configured to fully cover a wearer's head, to extend below the wearer's neckline, and to drape at least partially on and/or around the wearer's shoulders, and
the hood adjustment mechanism is configured to at least one of tighten or loosen the hood at the crown of the wearer's head and around or below the wearer's chin such that the hood can accommodate at least one of bulk hair styles on the wearer's head, or a beard on the wearer's chin.

14. The CBRN mask system of claim 13, wherein the hood can accommodate at least one of bulk hair styles on the wearer's head, or a beard on the wearer's chin while maintaining a seal around the bottom of the hood.

15. The CBRN mask system of claim 13, wherein the hood includes a stow ring around the bottom of the hood, and at least part of the hood is configured to stow within the stow ring and to be pulled from the stow ring as the mask system is donned.

16. The CBRN mask system of claim 13, wherein the hood adjustment mechanism includes an adjustment handle disposed below the wearer's chin, and an adjustment cord that runs from the adjustment handle toward the back of the hood and up to the crown of the hood.

17. The CBRN mask system of claim 16, wherein the adjustment cord runs in two separate strands from the adjustment handle toward the back of the hood and up to the crown of the hood, each of the separate strands weaving through parallel expandable channels of the hood.

18. A CBRN mask system, comprising:
a face mask including a face cover, a lens disposed in and surrounded by the face cover, and a gas interface disposed in and surrounded by the face cover;
a hood that surrounds, and is removably attached to, the face mask; and
a hood adjustment mechanism,
wherein, the hood is configured to fully cover a wearer's head, to extend below the wearer's neckline, and to drape at least partially on and/or around the wearer's shoulders, and
the hood adjustment mechanism is configured to at least one of tighten or loosen the hood at the crown of the wearer's head and around or below the wearer's chin such that the hood can accommodate at least one of head or facial geometries that do not form an adequate seal with a CBRN mask alone.

19. The CBRN mask system of claim 18, wherein the hood can accommodate at least one of head or facial geometries that do not form an adequate seal with a CBRN mask alone while maintaining a negative pressure seal around the bottom of the hood.

20. The CBRN mask system of claim 18, wherein the hood adjustment mechanism includes an adjustment handle disposed below the wearer's chin, and an adjustment cord that runs from the adjustment handle toward the back of the hood and up to the crown of the hood, and the adjustment cord runs in two separate strands from the adjustment handle toward the back of the hood and up to the crown of the hood, each of the separate strands weaving through parallel expandable channels of the hood.
